(19) United States
(12) Patent Application Publication
(10) Pub. No.: US 2019/0094853 A1
(43) Pub. Date: Mar. 28, 2019

(54) Flexion Mount

(71) Applicant: Jeffrey Paul Overall, Fountain Valley, CA (US)

(72) Inventor: Jeffrey Paul Overall, Fountain Valley, CA (US)

(21) Appl. No.: 15/712,470

(22) Filed: Sep. 22, 2017

(51) Int. Cl. G05D 1/00; F16B 2/22; H04N 5/232; H04N 5/225; H04N 5/38

(52) U.S. Cl. CPC G05D 1/0038; F16B 2/22; H04N 5/38; H04N 5/23293; H04N 5/2253; G05D 1/0016

(57) ABSTRACT

A method of mounting a phone or other portable electronic display (“PED”) to an object. Flexion plates composed of material capable of flexural rigidity are conjoined. Pressure caused by the flexural rigidity is used to couple a device with a remote controller or other object. Coupling is no longer dependent on the receptive components of the coupled object. The use of pressure allows quick installation and removal. A connector attached to the flexion plates enables attachment of a PED. A PED can be securely attached to a remote controller or a variety of other objects.

### TECHNICAL FIELD

The coupling of a mount to an object. More specifically, the use of external pressure caused by flexion plates to attach a mount for a portable electronic display to a remote controller.

### LIST OF PRIOR ART

U.S. Patents

| Patent Number: | Kind Code: | Grant Date: | Patentee: |
|---|---|---|---|
| 5,711,469 | A | 1998 Dec. 27 | Gormley |
| 6,519,144 | B1 | 2003 Feb. 11 | Henrie |
| 7,843,431 | B2 | 2010 Nov. 30 | Robbins |
| 8,388,243 | B1 | 2013 Mar. 5 | Smith |
| 8,690,460 | B2 | 2014 Apr. 8 | Kuehl |
| 8,903,568 | B1 | 2014 Dec. 2 | Wang |
| 9,482,931 | B1 | 2016 Nov. 1 | Clearman |
| 9,507,245 | B1 | 2016 Nov. 29 | Druker |
| 9,513,535 | B2 | 2016 Dec. 6 | Bennett |
| 9,533,760 | B1 | 2017 Jan. 3 | Wagreich |

### BACKGROUND/PRIOR ART

Remotely operated unmanned vehicles, including drones, are now capable of photography and recording video footage via integrated or attached cameras. The footage can be transmitted back to the operator to allow enhanced operation of the drone. Real-time transmission also allows for better control of the video footage and photographs taken. To fully utilize the real-time transmission capability, the user must be able to view the footage and operate the controller simultaneously. Most remote controllers do not have the capability to display the recorded footage. However, portable electronic displays (PED's), including phones, permit such viewing. Mounting a PED to the remote controller is an effective, and often the only way to view recorded footage while operating a drone.

Securely coupling a PED and remote controller is crucial to operation of a drone with, image capturing capacity. The PED and remote controller work in tandem to control the drone. They also serve as the terminal for image data transmitted from the drone camera. Camera settings may be controlled on either the remote controller or PED.

There has been development in methods and devices for attaching mounts for portable PED's. Methods exist for coupling an object by threading, clamping, magnetism or permanent alteration to the surface of the object. The proliferation of remote controlled devices has seen these methods used to attach mounts to remote controllers. Unfortunately, the existing methods are not optimal for remote controllers of all materials and dimensions. The methods of coupling mentioned above can cause damage or require permanent alteration to the controller. There is a need for a more versatile, less invasive method of coupling a mount to a remote controller.

The present invention allows removable attachment of a mount to remote controllers of all materials and dimensions. Flexion plates are used to couple the controller by external pressure. This allows for quick installation and removal, with no damage to the controller, or residue. It also allows for greater versatility, as the flexion plates can be configured to the dimensions of the remote controller. Coupling ability is not dependent on the remote controller surface dimensions, materials, or the receptive components of the remote controller. The flexural, rigidity of the flexion plates allows for a quick and easy removable attachment, while at the same time providing secure coupling. A PED can be quickly mounted to allow display of images captured by a drone camera.

### SUMMARY OF INVENTION

A device utilizing flexural rigidity to couple with a remote controller or other device is disclosed. A flexion, mount uses flexural rigidity to couple with the remote controller. An exemplary embodiment is described. Four flexion plates are conjoined. The flexion plates are comprised of polycarbonate, glassed filled nylon, or other material capable of flexural rigidity. The exemplary flexion plates are configured to contour to the remote controller. In their unstressed state, the flexion plates are slightly smaller than or the same dimension as the remote controller. A PED connector is attached to one of the flexion plates. In the exemplary embodiment the PED connector is a threaded stud and is attached to the top flexion plate. A PED mount may be connected to the PED connector.

The flexion plates work in unison to removably attach the flexion mount to the remote controller. The flexion plates expand for easy attachment and removal. Coupling is achieved by exerting pressure to expand the mount, and pressing or sliding the flexion mount over a device. When attached, the mounting surfaces of the flexion plates contour to the remote. The flexural rigidity of the flexion plates causes them to exert pressure on the device.

The flexion plates are constructed of material with sufficient yield stress to allow movement from repeated expansion without loss of the structural integrity of the unstressed position.

A hinge may divide one of the flexion plate. When the flexion plate is so divided it will have a lower and upper section. The hinge will allow movement of the upper and lower section relative to each other. The hinge may be comprised of a pivot pin and interlocking prongs containing pivot holes. The pivot pin may be inserted into the pivot holes, the pivot pin creating an axis of rotation. The hinge may range of motion may permit the top portion of the third flexion plate to fold down toward another flexion plate. The top portion of the flexion plate may be situated relatively parallel another plate when in this folded position. This reduces the relative volume of the flexion plate, improving storage.

A threaded screw, may integrally couple with one of the flexion plates. The threaded screw forms the PED connector in the exemplary embodiment. A modular knurled nut may contain a threaded opening corresponding to the threaded screw.

A PED mount may have female threaded socket corresponding with the threaded screw. The PED mount may couple with the PED connector by threading. The PED mount is configured to removably couple a PED (or other electronic device). The PED mount may comprise a side clamp as coupling means. Pressure fitting, snap-hooking, magnetism, and other means of may also be employed.

Using a knurled nut on the connector, the PED mount height and angle can be adjusted to achieve the desired orientation to the user. Data from the drone may be transmitted directly to the PED. If the data is transmitted to the remote controller, the PED is connected to the remote controller to receive the images transmitted from the unmanned vehicle. This may be done either by hardwire, e.g. USBcord, or wirelessly depending on the remote controller and PED capabilities. The drone can then be operated and recorded footage viewed. In the exemplary model the PED is located above the remote controller, in a position where it does not interfere with view or manipulation of the remote controller. The exemplary positioning also permits convenient viewing of the PED and easy access, to any controls contained on the PED interface. The user can use the transmitted images to effectively maneuver the unmanned vehicle. Photography and video recording can be controlled on either the PED or remote controller.

Alternate embodiments may include a different number of flexion plates. Embodiments including additional flexion plates may be desirable based on surface dimensions of the remote controller.

Embodiments comprised of three flexion plates are viable for some remote controllers.

Alternate embodiments permit attachment of a PED mount with a different part of the flexion mount. Depending on the activity or dimension of the remote controller, it may be more beneficial to display the PED, below, to the sides, or in front, of the remote controller.

Alternate embodiments of the invention include one or more openings allowing for USB or other input cables to be installed into the remote controller while the mount is attached. To receive transmitted images from some devices the PED must be connected by USB cable or other connector. An opening or openings allow for connection while not sacrificing the coupling ability of the flexion mount.

Alternate embodiments can be configured to couple with cameras, gimbal mounted cameras, or other devices to allow simultaneous viewing of recorded footage on a PED. (might be too broad).

Alternate embodiments may include one or more hinges allowing for the invention to be folded or otherwise compressed.

Alternate embodiments may include the ability to couple a plurality of PED Displays.

### DRAWING NUMBERS

10. Flexion Mount
12. PED
14. PED Mount
16. Remote Controller
18. Second Flexion Plate
20. Third Flexion Plate
21. Hinge
22. Pivot Pin
23. Interlocking Prongs
24. Knurled Nut
26. Threaded Insert
28. Connector
30. Hinging Holes
32. First Flexion Plate
34. Fourth Flexion Plate
36. Input slot

### BRIEF DESCRIPTION OF THE DRAWINGS

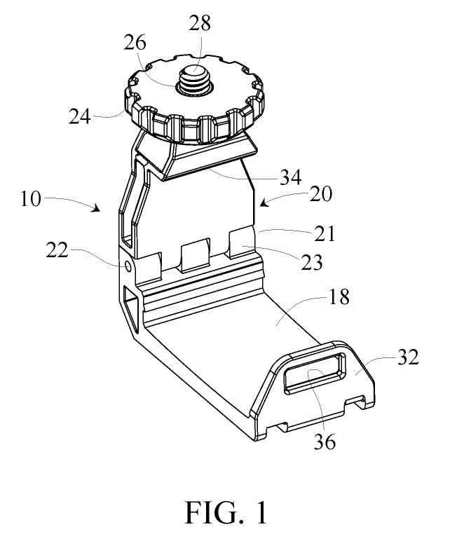

FIG. 1 shows a perspective view of the flexion mount.

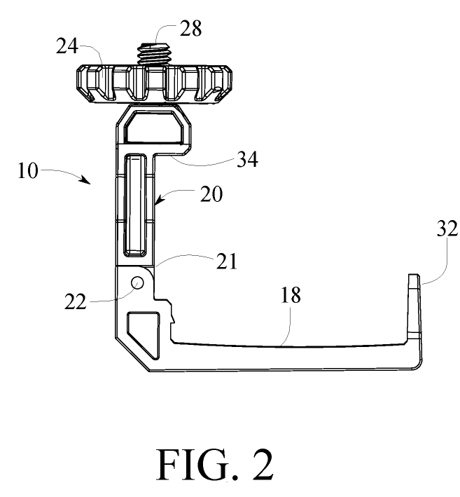

FIG. 2 shows a side view of the flexion mount.

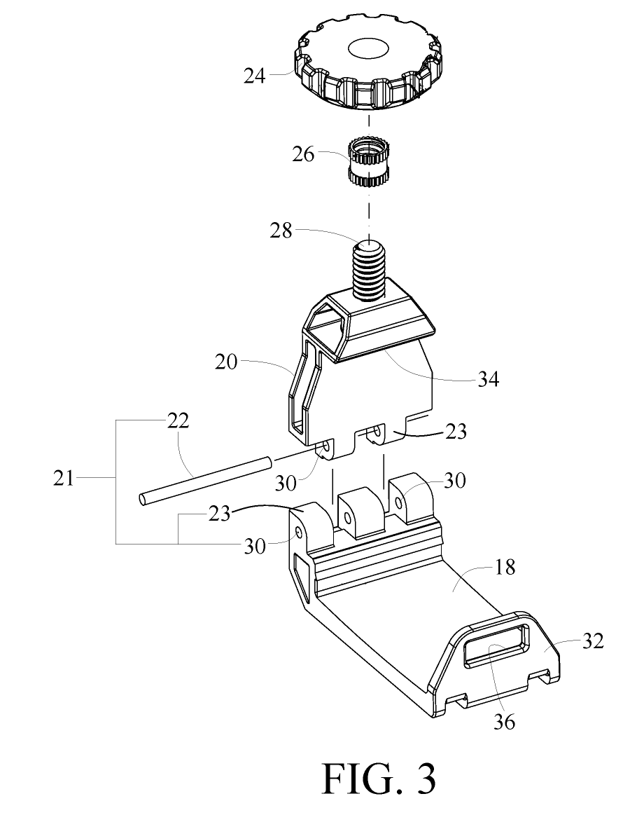

FIG. 3 shows an exploded view of the flexion mount.

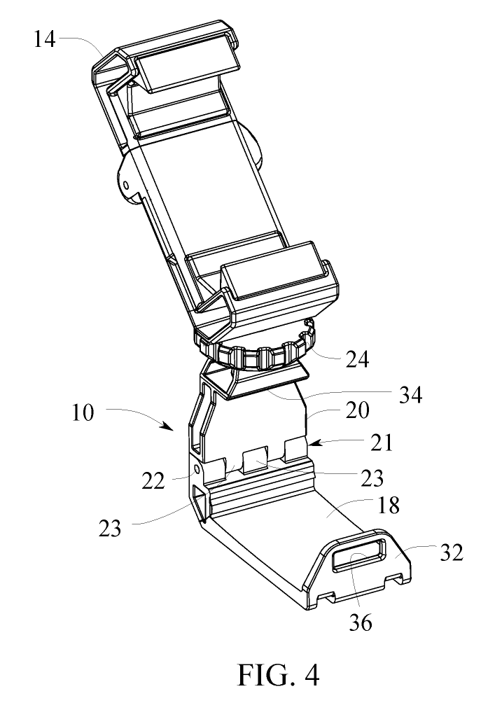

FIG. 4 shows a perspective view of the flexion mount with a PED mount attached.

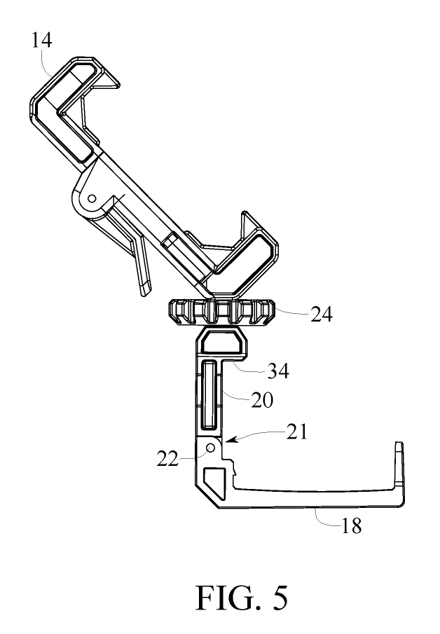

FIG. 5 shows a side view of the flexion mount with a PED mount attached.

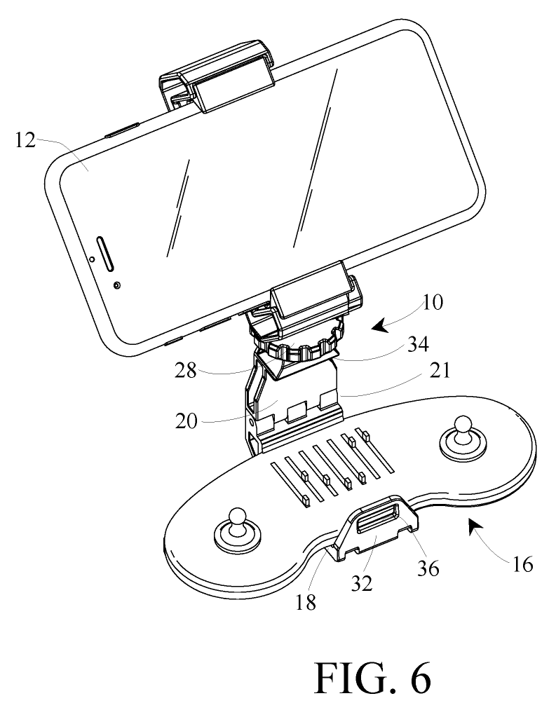

FIG. 6 shows a perspective view of the flexion mount in operation, with all components of the method attached.

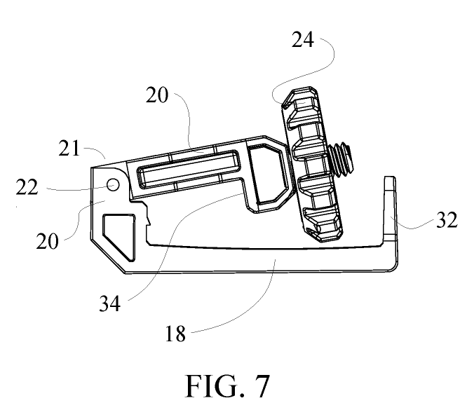

FIG. 7 shows a side view of the flexion mount in a folded position.

### DETAILED DESCRIPTION OF DRAWINGS

FIG. 1 depicts an exemplary embodiment of the flexion mount 10. A first flexion plate 32 is conjoined with second flexion plate 18. The first flexion plate 32 contains an input slot 36 to allow insertion of a USB cord or other type of connector into a mounted remote controller. An input slot 36 is beneficial if the remote controller must be hardwired to the PED or another object. A second flexion plate 18 conjoins with the third flexion plate 20. A third flexion plate 20 contains a protrusion with grooves where it conjoins with second flexion plate 18, as can be seen in FIG. 2. Though the protrusion and grooves may enhance coupling with particular remote controllers it is not necessary to achieve coupling through external pressure.

The third flexion plate 20 is conjoined with a fourth flexion plate 34. A connector 28 is conjoined with the top of the fourth flexion plate 34. The connector 28 in this embodiment is a threaded stud. A knurled nut 24 encircles the connector 28 and can be rotationally adjusted.

The knurled nut 24 is used to adjust a PED mount 14.

FIG. 3 shows the mechanical components of the flexion mount 10. A hinge 21 divides the upper and lower portions of the third flexion plate 20. The hinge 21 is comprised of a pivot pin 22 and hinging holes 30 that pass laterally through interlocking prongs 23. The hinging holes 30 align when the interlocking prongs 23 are engaged. The three bottom and two top interlocking prongs 23 are rounded to allow the top portion of the third flexion plate 20 to fold forward toward the second flexion plate 18. The alignment of the lower and upper segments of the third flexion plate 20 in FIG. 1-6 is a functional position of the hinge 21. The interlocking prongs 23 abut the opposite segment of the third flexion plate 20 and are prevented from moving past the vertical orientation of the functional position. The hinge 21 is integrated into the third flexion arm 20. The hinge 21 enables both movement of the segments of the third flexion arm 20 relative to each other while providing sufficient force resistance in the functional position to allow secure coupling of a device.

The knurled nut 24 and a threaded insert 26 are exploded from the connector 28. The threaded insert 26 enables adjustment of the knurled, nut 24 on the connector 28.

FIG. 4 depicts a PED mount 14 coupled to the connector 28. The PED mount 14 is attached to the connector 28 by threading. The PED mount 14 is positioned on the connector 28 for the desired orientation to the user. The knurled nut 24 is then tightened to fasten the PED mount 14 in position. Other methods of coupling a PED mount to the flexion mount 10, such as snap hooks or permanent attachment, are possible.

The PED mount 14 is angled, to permit easy viewing and interaction with a PED interface, as can be seen in FIG. 5. In this embodiment the PED mount 14 is positioned at roughly 45′ to the third flexion plate 20. This orientation allows the user to view and interact with the PED while holding and operating the remote controller. Other orientations are possible.

FIG. 6 depicts the flexion mount 10 in operation. A remote controller 16 is coupled by the flexion plates 32,18,20,34. The flexion plates 32,18,20,34 expand to allow installation of the remote controller 16. When expansion ceases the flexion plates 32,18,20,34 abut and exert external pressure on the remote controller 16. In this embodiment, the remote controller 16 is coupled on four sides. The external force is sufficient to prevent transverse pressure from causing the remote controller 16 from dislodging in the direction of the uncoupled sides.

The remote controller 16 or a PED 12 receives the image data transmitted wirelessly from the drone camera. If the data is transmitted from the drone to the remote controller 16 it is transferred to the PED either by hardwire or wirelessly.

The PED 12 is attached to the PED mount 14. The PED 12 may displays transmitted images captured by a drone or other unmanned vehicle. In this embodiment the PED 12 is secured in a horizontal position.

FIG. 7 shows the flexion mount 10 in a folded position. The top segment of the third flexion plate 20 rotates around the axis created by the pivot pin 22, towards the second flexion plate 18. The top segment can be pressed down until the knurled nut 24 contacts the second flexion plate 18. The PED mount 14 is removed to allow folding of the top section of the third flexion plate 20 and PED connector towards the second flexion plate 18. The knurled nut 24 may also be removed to allow additional rotation toward the second flexion plate 18. The third flexion arm consumes less vertical space relative to the second flexion arm in the folded position. This may enable storage in spaces not capable of storage in the functional position, where the third flexion arm extends vertically on one plane. The third flexion arm consumes less vertical space relative to the second flexion arm.

The foregoing discussion discloses and describes merely exemplary methods and embodiments. As will be understood by those familiar with the art, the disclosed subject matter may be embodied in other specific forms without departing from the essence or characteristics thereof. Accordingly, the foregoing disclosure is intended to be illustrative, but not limiting, of the scope of the invention, which is set forth in the following claims.

I claim:

1. (canceled)

2. (canceled)

3. A device, comprising:
a) four conjoined flexion plates comprised of material allowing flexural rigidity, whereby said flexion plates may be displaced from their unstressed position and when so displaced exert force towards their unstressed position;
b) a connector attached with said flexion plates, whereby a mount can be attached;
c) said mount being capable of coupling a portable electronic display;
d) a hinge integrated with and dividing at least one of the flexion plates, said hinge allowing the divided flexion plate segments to move relative to each other.

4. (canceled)

5. The device recited in claim 3, wherein one or more of the flexion plates contain an opening or plurality of openings.

6. (canceled)

7. (canceled)

8. A device, comprising:
a) three conjoined flexion plates comprised of material allowing flexural rigidity, whereby said flexion plates exert external pressure as means of coupling with a remote controller,
b) a connector attached with said flexion plates, whereby a mount can be attached,
c) said mount being capable of coupling a portable electronic display;
d) a hinge integrated with and dividing at least one of the flexion plates, said hinge allowing the bisected flexion plate portions to move relative to each other;

9. (canceled)

10. The device recited in claim 8, wherein one or more of the flexion plates contain an opening or plurality of openings.
